(19) United States
(12) Patent Application Publication
(10) Pub. No.: US 2013/0021268 A1
(43) Pub. Date: Jan. 24, 2013

(54) TOUCH PANEL

(71) Applicants: Woo Jin Lee, Seoul (KR); Sang Su Hong, Gyunggi-do (KR); Jae Hun Kim, Seoul (KR); Chung Mo Yang, Gyunggi-do (KR); In Hyung Lee, Gyunggi-do (KR); Seul Gi Kim, Gyunggi-do (KR); Young Woo Lee, Gyunggi-do (KR)

(72) Inventors: Woo Jin Lee, Seoul (KR); Sang Su Hong, Gyunggi-do (KR); Jae Hun Kim, Seoul (KR); Chung Mo Yang, Gyunggi-do (KR); In Hyung Lee, Gyunggi-do (KR); Seul Gi Kim, Gyunggi-do (KR); Young Woo Lee, Gyunggi-do (KR)

(73) Assignee: SAMSUNG ELECTRO-MECHANICS CO., LTD., Gyunggi-do (KR)

(21) Appl. No.: 13/252,755

(22) Filed: Oct. 4, 2011

(30) Foreign Application Priority Data
Jul. 19, 2011 (KR) 1020110071395

(51) Int. Cl. G06F 3/041

(52) U.S. Cl. 345/173; 178/18.03

(57) ABSTRACT

Disclosed herein is a touch panel, including: a base substrate divided into an active area, a bezel area surrounding the active area, and a connection area provided outside the bezel area; sensing electrodes formed in the active area; and electrode wirings connected to the sensing electrodes and extended to the connecting area. Here, a predetermined portion of the base substrate is cut and the connection area is folded by using the predetermined portion as a boundary line such that the connection area is protruded outwardly from the base substrate. According to the present invention, the connection area is provided in the base substrate in a single body, thereby allowing omission of separate flexible printed cables, and thus, an attaching process of the flexible printed cable can also be omitted.

### CROSS REFERENCE TO RELATED APPLICATION

This application claims the benefit of Korean Patent Application No. 10-2011-0071395, filed on Jul. 19, 2011, entitled “Touch Panel”, which is hereby incorporated by reference in its entirety into this application.

### BACKGROUND OF THE INVENTION

1. Technical Field

The present invention relates to a touch panel.

2. Description of the Related Art

With the growth of computers using digital technology, devices assisting the computers have also been developed, and personal computers, portable transmitters and other personal information processors execute processing of text and graphics using a variety of input devices such as a keyboard, a mouse and so on.

While the rapid advancement of an information-oriented society has been widening the use of computers more and more, there have been occurring the problems of it being difficult to efficiently operate products using only the keyboard and mouse as being currently responsible for the input device function. Thus, the demand for a device that is simple, has minimal malfunction, and has the capability to easily input information is increasing.

Furthermore, current techniques for input devices exceed the level of fulfilling general functions and thus are progressing towards high reliability, durability, innovation, designing and manufacturing related techniques, etc. To this end, a touch panel has been developed as an input device capable of inputting information such as text and graphics, etc.

The touch panel is mounted on the display surface of an image display device such as an electronic organizer, a flat panel display including a liquid crystal display (LCD), a plasma display panel (PDP), an electroluminescence (El) element, or the like, or a cathode ray tube (CRT), so that a user selects desired information while viewing the image display device.

The touch panel is classifiable as a resistive type, a capacitive type, an electromagnetic type, a surface acoustic wave (SAW) type, and an infrared type. The type of touch panel selected is one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch panel. In particular, resistive and capacitive types are prevalently used at the present time.

However, in the touch panel according to the related art, a problem occurs in connecting an electrode wiring formed on a transparent substrate to a flexible printed cable (FPC). FIGS. 1 and 2 are plan views of a touch panel according to the prior art, and problems of the prior art will be described with reference to the drawings.

As shown in FIGS. 1 and 2, a touch panel 10 according to the prior art includes a transparent substrate 20, a sensing electrode 30 formed on the transparent substrate 20, signal wirings 40 extended from the sensing electrode 30 and gathered at one end of the transparent substrate 20, and a flexible printed cable 60 connecting the signal wirings 40 to a controller. Herein, the flexible printed cable 60 serves to transmit the signals generated from the sensing electrode 30 to the controller via the signal wirings 40. In order to secure reliability in signal transmission of the flexible printed cable 60, the flexible printed cable 60 and the electrode wirings 40 need to be securely attached. However, in the prior art, an anisotropic conductive film (ACF) or the like is applied to a connection part A of the flexible printed cable 60 and the electrode wiring 40 at the time of attachment of the flexible printed cable 60 and the electrode wiring 40. Therefore, terminal resistance occurs in the attachment process of the flexible printed cable 60 and the connection part A, and defects during the attachment process may occur. Furthermore, the connection part A is structurally weak even after the attachment process, and thus defects may occur when a predetermined level of strength is applied to the connection part A.

### SUMMARY OF THE INVENTION

The present invention has been made in an effort to provide a touch panel capable of omitting separate flexible printed cables and allowing mass production, by cutting a predetermined portion of a base substrate, in which a connection area is provided in a single body, and then folding the connection area by using the predetermined portion as a boundary line such that the connection area is protruded.

According to a preferred embodiment of the present invention, there is provided a touch panel including: a base substrate divided into an active area, a bezel area surrounding the active area, and a connection area provided outside the bezel area; sensing electrodes formed in the active area; and electrode wirings connected to the sensing electrodes and extended to the connecting area, wherein a predetermined portion of the base substrate is cut and the connection area is folded by using the predetermined portion as a boundary line such that the connection area is protruded outwardly from the base substrate.

The predetermined portion may be cut in a predetermined length in a direction from one side to the other side of the boundary between the bezel area and the connection area, and the connection area may be folded at a distal end of the predetermined portion.

The predetermined portion may include: a first predetermined portion defined as a portion in which a central portion of the boundary between the bezel area and the connection area is cut in a predetermined length; and a second predetermined portion defined as a portion which is cut substantially vertically from the first predetermined portion in the connection area to separate the connection area into two parts, the connection area being folded at both ends of the first predetermined portion to be separated into the two parts by the second predetermined portion.

The predetermined portion may include: a first predetermined portion defined as a portion in which a central portion of the boundary between the bezel area and the connection area is cut in a predetermined length; a second predetermined portion defined as a portion which is cut substantially vertically from one end of the first predetermined portion in the connection area; and a third predetermined portion defined as a portion which is cut substantially vertically from a distal end of the second predetermined portion in a direction of the other end of the first predetermined portion in the connection area to separate the connection area, the connection area being folded at the distal end of the second predetermined portion and folded at the other end of the first predetermined portion.

The sensing electrode may include: a first sensing electrode formed on one surface of the active area: and a second sensing electrode formed on the other surface of the active area, and, the electrode wiring may include: a first electrode wiring connected to the first sensing electrode and extended to one surface of the connection area; and a second electrode wiring connected to the second sensing electrode and extended to the other surface of the connection area.

The base substrate may be a flexible substrate.

The sensing electrode and the electrode wiring may be formed of the same material.

The sensing electrode and the electrode wiring may be formed of different materials.

The sensing electrode may formed of silver (Ag), copper (Cu), nickel (Ni), titanium (Ti), chrome (Cr), aluminum (Al), silver halide, indium tin oxide (ITO), or a combination thereof.

The electrode wiring may be formed of silver (Ag), copper (Cu), nickel (Ni), titanium (Ti), chrome (Cr), aluminum (Al), silver halide, indium tin oxide (ITO), or a combination thereof.

The touch panel may further include an adhesive layer provided on the base substrate to cover the sensing electrodes and the electrode wirings.

The adhesive layer may be made of an optical clear adhesive (OCA).

The touch panel may further include an insulating layer provided in the connection area to cover the electrode wirings.

The insulating layer may be formed by coating a film, a tape, a paste, or an ink.

The touch panel may further include an integrated circuit provided in the connection area, the integrated circuit being connected to the electrode wirings.

### BRIEF DESCRIPTION OF THE DRAWINGS

FIGS. 1 and 2 are plan views of a touch panel according to the prior art;

FIGS. 3 and 4 are plan views of a touch panel according to a first preferred embodiment of the present invention;

FIG. 5A is a cross-sectional view of the touch panel having an adhesive layer, taken along line A-A′ in FIG. 3;

FIG. 5B is a cross-sectional view of the touch panel in which an adhesive layer is provided, taken along line B-B′ in FIG. 4;

FIG. 6A is a cross-sectional view of the touch panel in which an insulating layer is provided, taken along line A-A′ in FIG. 3;

FIG. 6B is a cross-sectional view of the touch panel in which an insulating layer is provided, taken along line B-B′ in FIG. 4;

FIG. 7 is a plan view of the touch panel of FIG. 4, in which an integrated circuit is provided;

FIGS. 8 to 9 are plan views of a touch panel according to a second preferred embodiment of the present invention; and

FIGS. 10 and 11 are plan views of a touch panel according to a third preferred embodiment of the present invention.

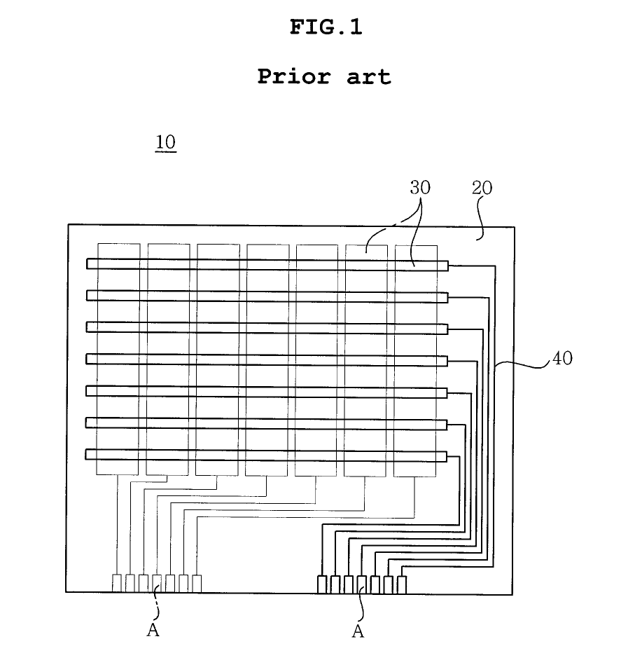

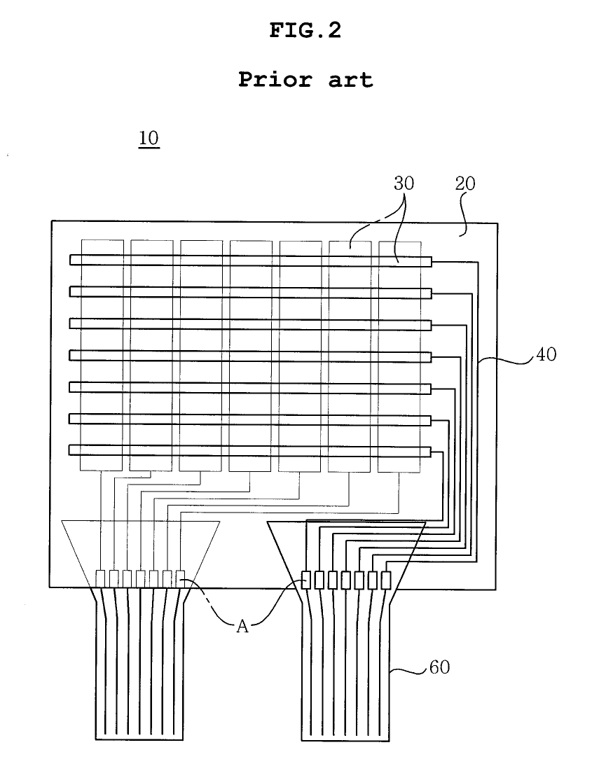

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, or the like are used to distinguish one element from another element, and the elements are not defined by the above terms. Further, in describing the present invention, a detailed description of related known functions or configurations will be omitted so as not to obscure the subject of the present invention.

Hereinafter, preferred embodiments of the present invention will be described in detail with reference to the accompanying drawings.

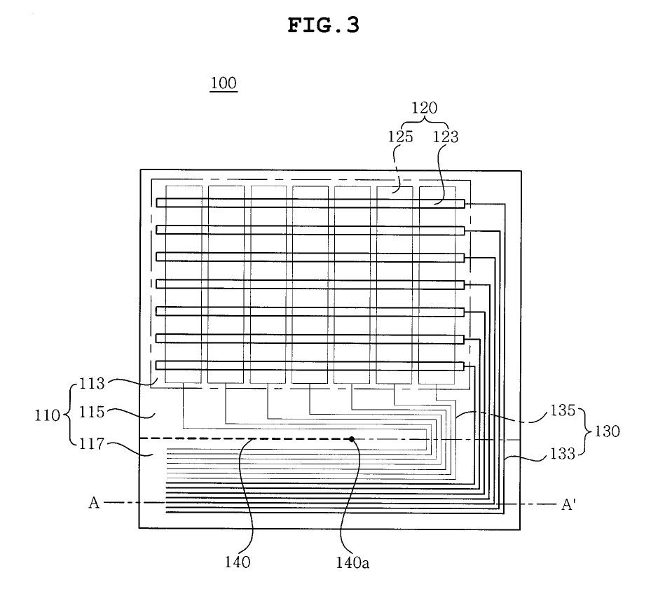

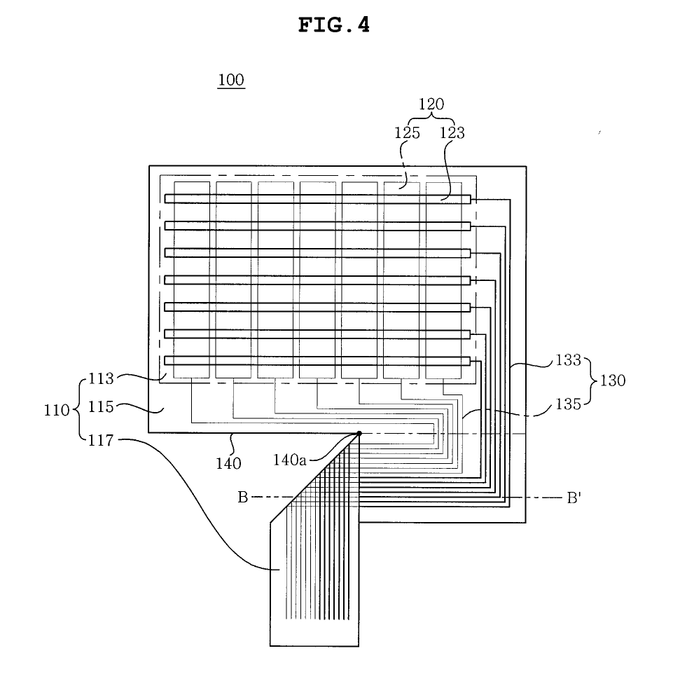

FIGS. 3 and 4 are plan views of a touch panel according to a first preferred embodiment of the present invention.

As shown in FIGS. 3 and 4, a touch panel 100 according to the present preferred embodiment includes a base substrate 110 divided into an active area 113, a bezel area 115 surrounding the active area 113, and a connection area 117 provided outside the bezel area 115; sensing electrodes 120 formed in the active area 113; and electrode wirings 130 connected to the sensing electrodes and extended to the connection area 117. Here, a predetermined portion 140 of the base substrate 110 is cut, and the connection area 117 is folded by using the predetermined portion 140 as a boundary line such that the connection area 117 is protruded outwardly from the base substrate 110.

The base substrate 110 serves to provide an area in which the sensing electrodes 120 and the wiring electrodes 130 are to be formed. Here, the base substrate 110 preferably has a holding force for holding the sensing electrodes 120 and the electrode wirings 130. Also, the base substrate 110 preferably has flexibility so that the connection area 117 can be folded to protrude. In consideration of the above-mentioned holding force and flexibility, the base substrate 110 may be formed of polyimide, polyester, polyethylene terephthalate (PET), polycarbonate (PC), polymethylmethacrylate (PMMA), polyethylenenaphthalate (PEN), polyethersulfone (PES), cyclic olefin polymer (COC), a triacetyl cellulose (TAC) film, a polyvinyl alcohol (PVA) film, a polyimide (PI) film, a polystyrene (PS), biaxially oriented polystyrene (K resin-containing biaxially oriented PS; BOPS), or the like, but not necessarily limited thereto.

Meanwhile, the base substrate 110 is divided into the active area 113, the bezel area 115, and a connection area 117. Here, the sensing electrodes 120 for recognizing touch of an input unit are formed in the active area 113, which is provided in the center of the base substrate 110. The electrode wirings 130 connected to the sensing electrodes 120 pass through the bezel area 115, which is provided at the edge of the active area 113 to surround the active area 113. In addition, the connection area 117 is connected to a controller for controlling the touch panel 110, and is provided outside the bezel area 115. Here, since the base substrate 110 has flexibility, the connection area 117 is foldable. The folded connection area 117 is protruded outwardly from the base substrate 110 (see, FIG. 4), and details with respect to this will be described later.

The sensing electrodes 120 serve to generate signals when the input unit is touched and allow a controller to recognize touched coordinates. The sensing electrodes 120 are formed in the active area 113 of the base substrate 110. Here, the sensing electrode 120 may be formed of silver (Ag), copper (Cu), nickel (Ni), titanium (Ti), chrome (Cr), aluminum (Al), silver halide, indium tin oxide (ITO), or the like. The sensing electrode 120 may be formed by a dry etching process, such as sputtering, evaporation, or the like, a wet etching process, such as dip coating, spin coating, roll coating, spray coating, or the like, or may be formed by a direct patterning process, such as screen printing, gravure printing, inkjet printing, or the like. In addition, the sensing electrode 120 may be patterned in a bar-shaped pattern, as shown in the drawings, or may be patterned in any pattern known in the art, such as a diamond pattern, a circular pattern, a mesh pattern, or the like.

The electrode wirings 130 serve to electrically connect the sensing electrodes 120 and the controller, and extended from the sensing electrodes 120 to the connection area 117. Here, the electrode wiring 130 may be formed of the same material as the sensing electrode 120, such as silver (Ag), copper (Cu), nickel (Ni), titanium (Ti), chrome (Cr), aluminum (Al), silver halide, indium tin oxide (ITO), or the like. As such, when the electrode wiring 130 and the sensing electrode 120 are formed of the same material, the electrode wiring 130 and the sensing electrode 120 are formed in a single body through a single process, thereby simplifying the manufacturing process. However, the electrode wiring 130 and the sensing electrode 120 need not be formed of the same material, and the electrode wiring 130 and the sensing electrode 120 may be, of course, formed of different materials as necessary.

Meanwhile, as shown in the drawings, the sensing electrode 120 and the electrode wiring 130 may be formed on both surfaces of the base substrate 110. For example, the sensing electrode 120 may include a first sensing electrode 123 formed on one surface of the active area 113 and a second sensing electrode 125 formed on the other surface of the active area 113. In addition, the electrode wiring 130 may include a first electrode wiring 133 connected to the first sensing electrode 123 and extended to one surface of the connection area 117, and a second electrode wiring 135 connected to the second sensing electrode 125 and extended to the other surface of the connection area 117. However, the constitution in which the sensing electrode 120 and the electrode wiring 130 are formed on both surfaces of the base substrate 110 is for only one example. The sensing electrode 120 and the electrode wiring 130 may be formed on only one surface of the base substrate 110.

The touch panel 100 according to the present preferred embodiment is characterized in which the connection area 117 of the base substrate 110 is substituted for the flexible printed cable. Hereinafter, the connection area 117 will be described more specifically.

The connection area 117 is folded by using the predetermined portion 140, along which the base substrate 110 is cut, as a boundary line, and thus, the connection area 117 is protruded outwardly from the base substrate 110. Here, the predetermined portion 140 is a portion in which the base substrate 110 is cut in a predetermined length from one side toward the other side of the boundary between the bezel area 115 and the connection area 117. Here, since the bezel area 115 and the connection area 117 are not completely cut, the electrode wirings 130 are extended through the other side (a side contrary to one side from which the predetermined portion 140 begins) of the boundary between the bezel area 115 and the connection area 117. The predetermined portion 140 of the base substrate 110 is cut (see, FIG. 3), and the connection area 117 is turned over and folded at a distal end 140a of the predetermined portion 140 so that the connection area 117 can be protruded outwardly from the base substrate 110 (see, FIG. 4). The electrode wirings 130 can be connected to the controller through the protruded connection area 117. Therefore, the electrode wiring 130 can be connected to the controller without separate flexible printed cables. As a result, an attachment process of the flexible printed cable can be skipped, and thus the manufacturing cost can be reduced. Furthermore, the base substrate 110 is not prepared in a protruded type at the initial stage, but the base substrate 110 is prepared in a simple design, such as a quadrilateral in plane or the like (see, FIG. 3), and the predetermined portion 140 of the base substrate 110 is cut and then folded, thereby protruding the connection area 117 (see, FIG. 4). As a result, the manufacturing process can be simplified and mass production can be achieved.

Meanwhile, when the connection area 117 is folded at the distal end 140a of the predetermined portion 140, the first electrode wirings 130 formed in the connection area 117 (especially, the first electrode wirings 133 formed on one surface of the connection area 117) may be contacted with each other, thereby causing short circuit (see, FIG. 4). An adhesive layer 150 may be employed in order to prevent this short circuit.

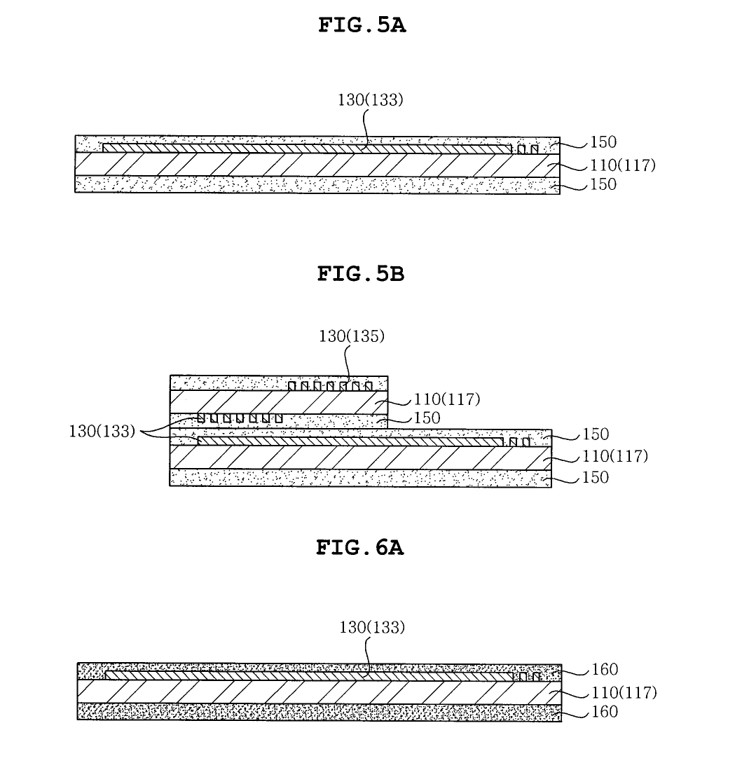

FIG. 5A is a cross-sectional view of the touch panel in which an adhesive layer is provided, taken along line A-A′ in FIG. 3, and FIG. 5B is a cross-sectional view of the touch panel in which an adhesive layer is provided, taken along line B-B′ in FIG. 4. When the adhesive layer 150 is provided to cover the electrode wirings 130, as shown in FIG. 5A, the adhesive layer 150 can prevent the short circuit, which is caused by contacting the electrode wirings 130 with each other even though the connection area 117 is folded, as shown in FIG. 5B.

A method for forming the adhesive layer 150 will be described. First, the adhesive layer 150 is attached on the entire surface of the base substrate to cover the sensing electrodes 120 and the electrode wirings 130. Then the adhesive layer 150 and the predetermined portion 140 are simultaneously cut, and then the connection area 117 is folded. As such, when the adhesive layer 150 is coated on the entire surface of the base substrate 110 before the predetermined portion 140 of the base substrate 110 is cut, a coating process of the adhesive layer 150 is easily performed. Meanwhile, a material for the adhesive layer 150 is not particularly limited, but an optical clear adhesive (OCA) having transparency is preferably used since the adhesive layer 150 is coated in the active area 113.

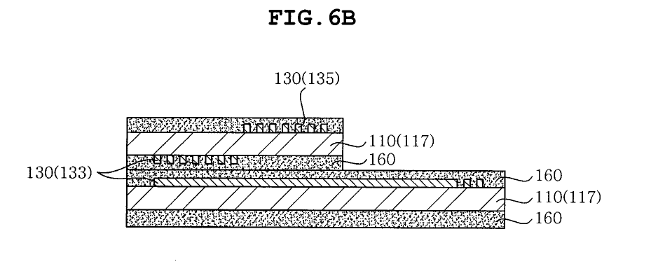

However, the adhesive layer 150 need not be coated on the entire surface of the base substrate 110. FIG. 6A is a cross-sectional view of the touch panel in which an insulating layer is provided, taken along line A-A′ in FIG. 3, and FIG. 6B is a cross-sectional view of the touch panel in which an insulating layer is provided, taken along line B-B′ in FIG. 4. As shown in FIGS. 6A and 6B, an insulating layer 160 is formed on only the connection area 117, thereby preventing short circuit due to contact of the electrode wirings 130 with each other. Here, the insulating layer 160 may be formed by coating a film, a tape, a paste, or ink, which is made of a transparent or opaque organic material.

Meanwhile, since the electrode wirings 130 need to be connected to the controller, it is preferable to expose a portion of each of the electrode wirings 130 by removing a portion of the adhesive layer 150 or the insulating layer 160, which is formed on an end portion of the connection area 117.

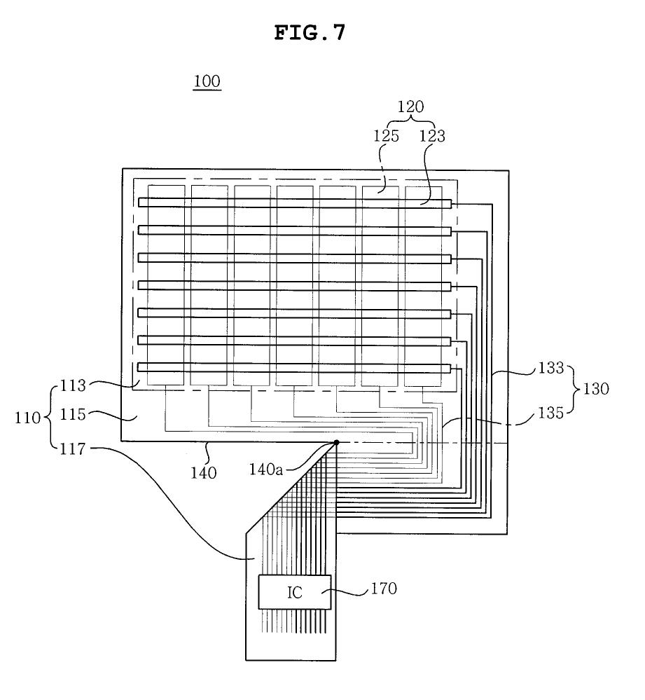

FIG. 7 is a plan view of the touch panel of FIG. 4, in which an integrated circuit is provided. As shown in FIG. 7, an integrated circuit 170 connected to the electrode wirings 130 may be provided in the connection area 117. Here, the integrated circuit 170 may include terminal patterns, which are connected to other boards, such as the controller and the like. In addition, the integrated circuit 170 may be mounted on the connection area 117 of the base substrate 110 having flexibility in a chip on film (COF) type. The integrated circuit 170 is preferably mounted on the connection area 117 after the connection area 117 is folded, due to the characteristic of manufacturing process.

Meanwhile, the touch panel 100 according to the present preferred embodiment is combined with an image display device, such as a liquid crystal display (LCD), a plasma display panel (PDP), an electroluminescence (EL), a cathode ray tube (CRT) or the like.

Here, if the image display device has non-flexibility, the base substrate 110 is also combined with this image display device, and thus, flexibility thereof can not be realized. However, since the connection area 117 protruded from the base substrate 110 is not combined with the image display device, flexibility thereof can be realized. Therefore, the connection area 117 is easily connected to the controller or the like.

However, if the image display device has flexibility, both the image display device and the base substrate 110 have flexibility. Therefore, flexibility of both can be realized even after both are combined with each other, and thus, this structure can be applied to a flexible display or the like.

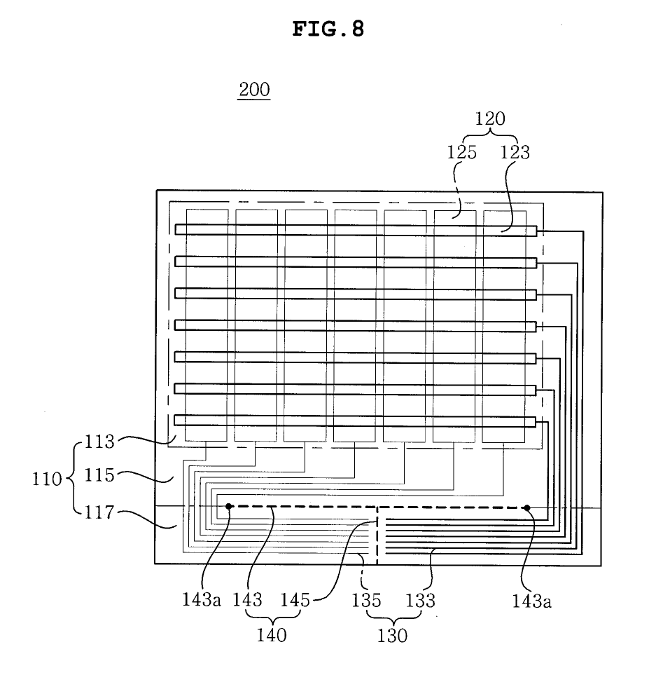

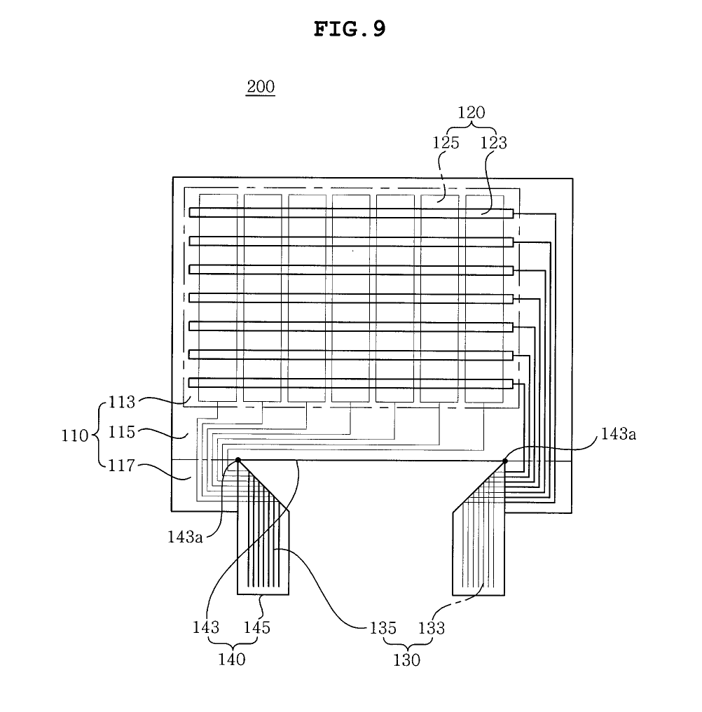

FIGS. 8 and 9 are plan views of a touch panel according to a second preferred embodiment of the present invention.

As shown in FIGS. 8 and 9, the most significant difference between the touch panel 200 according to the present preferred embodiment and the touch panel 100 according to the first preferred embodiment is a type in which the connection area 117 is folded. Therefore, the present preferred embodiment will be described based on the type in which the connection area 117 is folded, and a description overlapping with the first preferred embodiment will be omitted.

A connection area 117 of a touch panel 200 according to the present preferred embodiment is folded by using the predetermined portion 140, along which the base substrate 110 is cut, as a boundary line such that the connection area 117 is protruded outwardly from the base substrate 110. Here, the predetermined portion 140 includes a first predetermined portion 143 and a second predetermined portion 145. The first predetermined portion 143 is a portion in which a central portion of the boundary between the bezel area 115 and the connection area 117 is cut in a predetermined length. The second predetermined portion 145 is a portion which is cut substantially vertically from the first predetermined portion 143 in the connection area 117 to separate the connection area 117 into two parts. In other words, the first predetermined portion 143 and the second predetermined portion 145 meet in a “T” letter shape. Since the bezel area 115 and the connection area 117 are not completely cut, but only the central portion of the base substrate 110 is cut, the electrode wirings 130 are extended through both sides of the boundary between the bezel area 115 and the connection area 117. More specifically, the first electrode wirings 133 formed on one surface of the connection area 117 are extended through one side of the boundary between the bezel area 115 and the connection area 117, and the second electrode wirings 135 formed on the other surface of the connection area 117 are extended through the other side of the boundary between the bezel area 115 and the connection area 117, and thus, the first electrode wirings 133 and the second electrode wirings 135 can be separated from each other. When the predetermined portion 140 of the base substrate 110 is cut (see, FIG. 8), the connection area 117 is separated into two parts by the second predetermined portion 145, and then folded at both distal ends 143a of the first predetermined portion 143, and thus, the separated two parts of the connection area 117 are protruded outwardly from the base substrate 110 (see, FIG. 9). As a result, the electrode wirings 130 can be connected to the controller through the protruded connection area 117, and thereby allowing omission of the flexible printed cable.

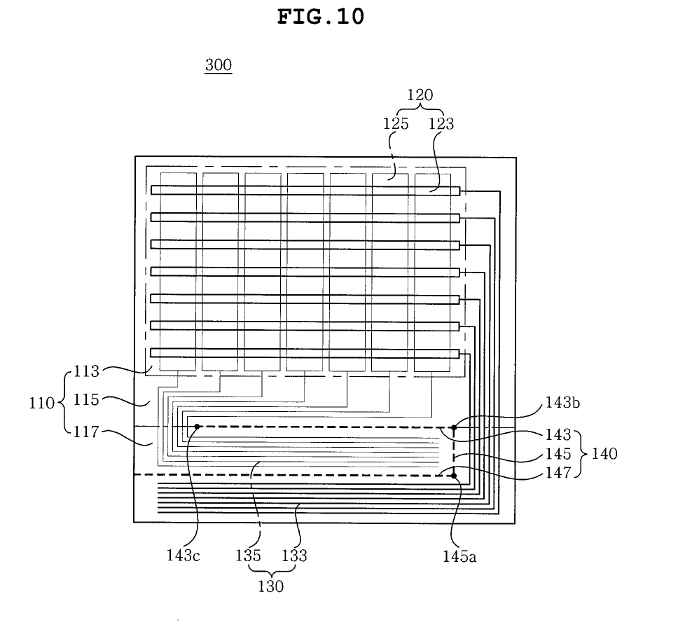

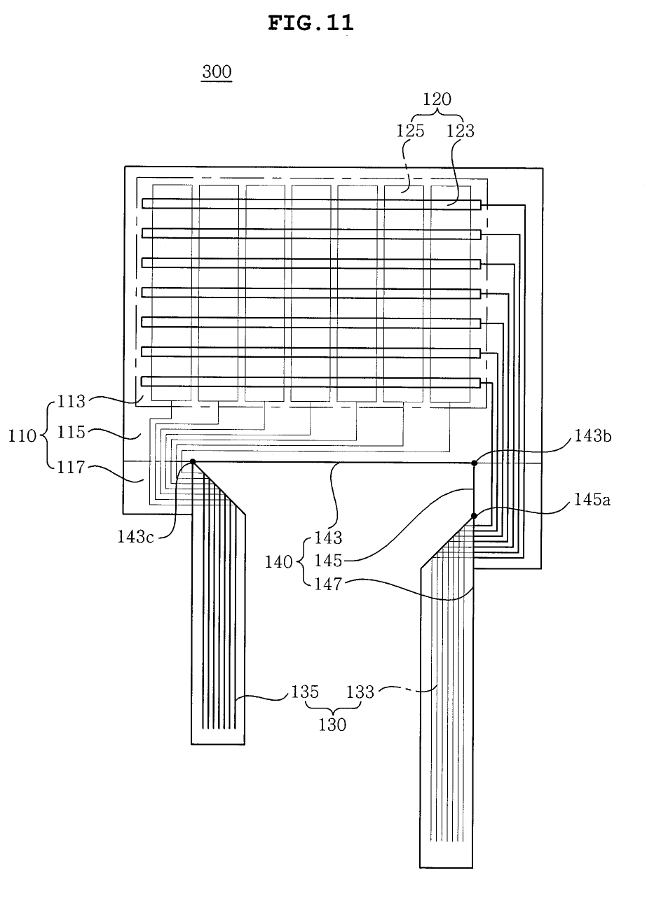

FIGS. 10 and 11 are plan views of a touch panel according to a third preferred embodiment of the present invention.

As shown in FIGS. 10 and 11, a touch panel 300 according to the present preferred embodiment is different from the touch panels 100 and 200 according to the first and second preferred embodiments in view of a type in which the connection area 117 is folded. Therefore, the present preferred embodiment will be described based on the type in which the connection area 117 is folded, and a description overlapping with the first and second preferred embodiments will be omitted.

Similarly in the touch panels 100 and 200 according to the first and second preferred embodiments, the connection area 117 of a touch panel 300 according to the present preferred embodiment is also folded by using the predetermined portion 140, along which the base substrate 110 is cut, as a boundary line, such that the connection area 117 is protruded outwardly from the base substrate 110. Here, the predetermined portion 140 includes a first predetermined portion 143, a second predetermined portion 145, and a third predetermined portion 147. The first predetermined portion 143 is a portion in which a central portion of the boundary between the bezel area 115 and the connection area 117 is cut in a predetermined length. The second predetermined portion 145 is a portion which is cut substantially vertically from one end 143b of the first predetermined portion 143 in the connection area 117. The third predetermined portion 147 is a portion that is cut substantially vertically from a distal end 145a of the second predetermined portion 143 (in a direction of the other end 143c of the first predetermined portion 143) in the connection area 117 to separate the connection area 117. In other words, the first predetermined portion 143, the second predetermined portion 145, and the third predetermined portion 147 meet in a “ [symbol] ” letter shape. Since the bezel area 115 and the connection area 117 are not completely cut but only the central portion of the base substrate is cut, the electrode wirings 130 are extended through both sides of the boundary between the bezel area 115 and the connection area 117. More specifically, the first electrode wirings 133 formed on one surface of the connection area 117 are extended through one side of the boundary between the bezel area 115 and the connection area 117, and an outside of the first, second, and third predetermined portions 143, 145, and 147, and the second electrode wirings 135 formed on the other surface of the connection area 117 are extended through the other side of the boundary between the bezel area 115 and the connection area 117, and an inside of the first, second, and third predetermined portions 143, 145, and 147, thereby allowing the first electrode wiring 133 and the second electrode wiring 135 to be separated. When the predetermined portion 140 of the base substrate 110 is cut (see, FIG. 10), the connection area 117 is separated into two, and then folded at both distal ends 145a of the second predetermined portion 145 and the other end 143c of the first predetermined portion 143, and thus, the separated connection area parts are protruded outwardly from the base substrate 110 (see, FIG. 11). As a result, the electrode wirings 130 can be connected to the controller through the protruded connection area 117, and thereby allowing omission of the flexible printed cable.

According to the present invention, the connection area is provided in the base substrate in a single body, thereby allowing omission of separate flexible printed cables, and thus, an attaching process of the flexible printed cable can also be omitted.

Furthermore, according to the present invention, even if the base substrate is formed in a simple design, such as a quadrilateral in plane or the like, and the predetermined portion of the base substrate is cut and then folded, thereby protruding the connection area. As a result, the manufacturing process can be simplified and mass production can be achieved.

Although the preferred embodiments of the present invention have been disclosed for illustrative purposes, they are for specifically explaining the present invention and thus a touch panel according to the present invention is not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A touch panel, comprising:
a base substrate divided into an active area, a bezel area surrounding the active area, and a connection area provided outside the bezel area;
sensing electrodes formed in the active area; and
electrode wirings connected to the sensing electrodes and extended to the connecting area,
wherein a predetermined portion of the base substrate is cut and the connection area is folded by using the predetermined portion as a boundary line such that the connection area is protruded outwardly from the base substrate.

2. The touch panel as set forth in claim 1, wherein the predetermined portion is cut in a predetermined length in a direction from one side to the other side of the boundary between the bezel area and the connection area, and the connection area is folded at a distal end of the predetermined portion.

3. The touch panel as set forth in claim 1, wherein the predetermined portion includes:
a first predetermined portion defined as a portion in which a central portion of the boundary between the bezel area and the connection area is cut in a predetermined length; and
a second predetermined portion defined as a portion which is cut substantially vertically from the first predetermined portion in the connection area to separate the connection area into two parts,
the connection area being folded at both ends of the first predetermined portion to be separated into the two parts by the second predetermined portion.

4. The touch panel as set forth in claim 1, wherein the predetermined portion includes:
a first predetermined portion defined as a portion in which a central portion of the boundary between the bezel area and the connection area is cut in a predetermined length;
a second predetermined portion defined as a portion which is cut substantially vertically from one end of the first predetermined portion in the connection area; and
a third predetermined portion defined as a portion which is cut substantially vertically from a distal end of the second predetermined portion in a direction of the other end of the first predetermined portion in the connection area to separate the connection area,
the connection area being folded at the distal end of the second predetermined portion and folded at the other end of the first predetermined portion.

5. The touch panel as set forth in claim 1, wherein the sensing electrode includes:
a first sensing electrode formed on one surface of the active area: and
a second sensing electrode formed on the other surface of the active area, and,
wherein the electrode wiring includes:
a first electrode wiring connected to the first sensing electrode and extended to one surface of the connection area; and
a second electrode wiring connected to the second sensing electrode and extended to the other surface of the connection area.

6. The touch panel as set forth in claim 1, wherein the base substrate is a flexible substrate.

7. The touch panel as set forth in claim 1, wherein the sensing electrode and the electrode wiring are formed of the same material.

8. The touch panel as set forth in claim 1, wherein the sensing electrode and the electrode wiring are formed of different materials.

9. The touch panel as set forth in claim 1, wherein the sensing electrode is formed of silver (Ag), copper (Cu), nickel (Ni), titanium (Ti), chrome (Cr), aluminum (Al), silver halide, indium tin oxide (ITO), or a combination thereof.

10. The touch panel as set forth in claim 1, wherein the electrode wiring is formed of silver (Ag), copper (Cu), nickel (Ni), titanium (Ti), chrome (Cr), aluminum (Al), silver halide, indium tin oxide (ITO), or a combination thereof.

11. The touch panel as set forth in claim 1, further comprising an adhesive layer provided on the base substrate to cover the sensing electrodes and the electrode wirings.

12. The touch panel as set forth in claim 11, wherein the adhesive layer is made of an optical clear adhesive (OCA).

13. The touch panel as set forth in claim 1, further comprising an insulating layer provided in the connection area to cover the electrode wirings.

14. The touch panel as set forth in claim 13, wherein the insulating layer is formed by coating a film, a tape, a paste, or ink.

15. The touch panel as set forth in claim 1, further comprising an integrated circuit provided in the connection area, the integrated circuit being connected to the electrode wirings.
